(19) United States
(12) Patent Application Publication
(10) Pub. No.: US 2024/0184269 A1
(43) Pub. Date: Jun. 6, 2024

(54) GENERATION OF "PLAIN LANGUAGE" DESCRIPTIONS SUMMARY OF AUTOMATION LOGIC

(71) Applicant: Seegrid Corporation, Pittsburgh, PA (US)

(72) Inventor: Atticus Huberts, Pittsburgh, PA (US)

(21) Appl. No.: 18/527,715

(22) Filed: Dec. 4, 2023

Related U.S. Application Data
(60) Provisional application No. 63/430,195, filed on Dec. 5, 2022.

(51) Int. Cl. G05B 19/4155

(52) U.S. Cl. CPC G05B 19/4155; G05B 2219/50391

(57) ABSTRACT

A system, comprising at least one autonomous mobile robot (AMR); and a management system comprising at least one processor configured to: identify one or more configuration details; and translate the one or more configuration details into one or more plain language descriptions. The system and method may also provide the one or more plain language summaries of job configuration details to a user, via a display.

### CROSS REFERENCE TO RELATED APPLICATIONS

The present application claims priority to U.S. Provisional Appl. 63/430,195, filed on Dec. 5, 2022, entitled Generation of “Plain Language” Descriptions Summary of Automation Logic, the contents of which are incorporated herein by reference.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); International Application No.: PCT/US23/033818, filed on Sep. 27, 2023, entitled Shared Resource Management System and Method; International Application No.: PCT/US23/079141, filed on Nov. 8, 2023, entitled System And Method For Definition Of A Zone Of Dynamic Behavior With A Continuum Of Possible Actins and Locations Within Same; International Application No.: PCT/US23/078890, filed on Nov. 7, 2023, entitled Method And System For Calibrating A Light-Curtain; International Application No.: PCT/US23/036650, filed on Nov. 2, 2023, entitled System and Method for Optimized Traffic Flow Through Intersections with Conditional Convoying Based on Path Network Analysis; U.S. Provisional Appl. 63/430,184 filed on Dec. 5, 2022, entitled Just in Time Destination Definition and Route Planning; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,190 filed on Dec. 5, 2022, entitled Configuring a System That Handles Uncertainty with Human and Logic Collaboration in A Material Flow Automation Solution; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and US Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Pat. No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number 2023/0376030, Published on Nov. 23, 2023, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and autonomous mobile robots (AMRs). In particular, the inventive concepts may be related to systems and methods in the field of material flow in a system that uses mobile robots and humans.

### BACKGROUND

Within increasing numbers and types of environments autonomous vehicles may travel through areas and/or along pathways that are shared with other vehicles and/or pedestrians. Such other vehicles can include other autonomous vehicles, semi-autonomous vehicles, and/or manually operated vehicles. The autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation. Herein, vehicles that are configured for autonomous navigation are referred to as AMRs.

Multiple AMRs may have access to an environment and both the state of the environment and the state of an AMR are constantly changing. The environment can be within, for example, a warehouse or large storage space or facility and the AMRs can include, but are not limited to, pallet lifts, pallet trucks, and tuggers.

Configuring a fleet of AMRs to perform work can be a complex undertaking. To optimize system performance, it is imperative that this configuration be correctly set by the user. An incorrectly configured system will directly dictate the movement and behavior of the AMRs in an undesired or even potentially dangerous way. In some instances it is difficult to review configuration instructions.

### SUMMARY

In accordance with various aspects of the inventive concepts, provided is a system, comprising: at least one autonomous mobile robot (AMR); and a management system comprising at least one processor configured to: identify one or more configuration details; and translate the one or more configuration details into one or more plain language descriptions.

In various embodiments, the system further comprises a graphical user interface configured to display the one or more plain language descriptions.

In accordance with another aspect of the inventive concepts, provided is a management system, comprising: at least one processor configured to: identify one or more configuration details; and translate the one or more configuration details into one or more plain language descriptions.

In various embodiments, the management system communicates with a graphical user interface, the graphical user interface configured to display the one or more plain language descriptions.

In accordance with another aspect of the inventive concepts, provided is an autonomous mobile robot (AMR) comprising: at least one processor configured to: identify one or more configuration details; and receive a translation of the one or more configuration details into one or more plain language descriptions.

In various embodiments, the AMR further comprises a graphical user interface configured to display the one or more plain language descriptions.

In accordance with another aspect of the inventive concepts, provided is a method, comprising the steps of: providing at least one autonomous mobile robot (AMR); providing a management system comprising at least one processor; identifying one or more configuration details; and translating the one or more configuration details into one or more plain language descriptions.

In various embodiments, the method further comprises the steps of: providing a graphical user interface; and displaying the one or more plain language descriptions at the graphical user interface.

In accordance with another aspect of the inventive concepts, provided is a method, comprising the steps of: identifying one or more configuration details; and translating the one or more configuration details into one or more plain language descriptions.

In various embodiments, the method further comprises the steps of: providing a graphical user interface; and displaying the one or more plain language descriptions at the graphical user interface.

In accordance with another aspect of the inventive concepts, provided is a method, comprising the steps of: identifying one or more configuration details; and receiving a translation of the one or more configuration details into one or more plain language descriptions.

In various embodiments, the method further comprises the steps of: providing a graphical user interface; and displaying the one or more plain language descriptions at the graphical user interface.

In example embodiments a system, includes a material flow management system comprising a processor configured to: accept from a user one or more robotic material flow job configuration details; translate the one or more configuration details into one or more plain language summaries of the job configuration details; and provide the one or more plain language summaries of job configuration details to a user.

In example embodiments a system, includes a material flow management system comprising a processor configured to provide the one or more plain language summaries to a user through a graphical user interface.

In example embodiments a system, includes a material flow management system comprising a processor configured to prompt a user to accept or reject job configuration details in response to the presentation of a plain language summary of the configuration details.

In example embodiments a system, includes a material flow management system comprising a processor configured to respond to the acceptance of configuration details by storing the configuration details as a template for a robotic material flow job.

In example embodiments a system, includes a material flow management system comprising a processor configured to prompt the input of configuration details, including a trigger and a step, for the robotic material flow job configuration.

In example embodiments a system, includes a material flow management system comprising a processor configured to present the stored template to a user when the job is called and is responsive to user input regarding job configuration specifications to provide an instance of the job.

In example embodiments a system, includes a material flow management system comprising a processor configured to accept location-specific input in the form of a direct location within a facility managed by the system in the context of the stored template.

In example embodiments a system, includes a material flow management system comprising a processor configured to accept location-specific input in the form of a group of locations within a facility managed by the system in the context of the stored template.

In example embodiments a system, includes a material flow management system comprising a processor configured to accept input in the form of a group of robots within a facility managed by the system in the context of the stored template.

In example embodiments a method includes a material flow management system comprising a processor, accepting from a user one or more robotic material flow job configuration details; translating the one or more configuration details into one or more plain language summaries of the job configuration details; and providing the one or more plain language summaries of job configuration details to a user.

In example embodiments a method includes system providing the one or more plain language summaries to a user through a graphical user interface.

In example embodiments a method includes the system prompts a user to accept or reject job configuration details in response to the presentation of a plain language summary of the configuration details.

In example embodiments a method includes the system responding to the acceptance of configuration details by storing the configuration details as a template for a robotic material flow job.

In example embodiments a method includes the system prompting the input of configuration details, including a trigger and a step, for the robotic material flow job configuration.

In example embodiments a method includes the system presenting the stored template to a user when the job is called and is responsive to user input regarding job configuration specifications to provide an instance of the job.

In example embodiments a method includes the system accepting location-specific input in the form of a direct location within a facility managed by the system in the context of the stored template.

In example embodiments a method includes the system accepting location-specific input in the form of a group of locations within a facility managed by the system in the context of the stored template.

In example embodiments a method includes the system accepting input in the form of a group of robots within a facility managed by the system in the context of the stored template.

In example embodiments a robotic materials flow system includes an AMR and a processor configured to: accept from a user one or more robotic material flow job configuration details; translate the one or more configuration details into one or more plain language summaries of the job configuration details; and provide the one or more plain language summaries of job configuration details to a user.

In example embodiments a robotic materials flow system includes a processor configured to prompt the user to accept or reject the configuration details based on the plain language summaries and to store the job configuration details as a template in response to user acceptance of the details.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of an AMR forklift, in accordance with aspects of the inventive concepts;

FIG. 2 is a block diagram of a robotic materials flow system in accordance with principles of inventive concepts;

FIG. 3 is a diagram of an example embodiment of facility employing a robotic materials flow system in accordance with principles of inventive concepts;

FIG. 4 is a flow chart depicting an example job configuration process in accordance with principles of inventive concepts;

FIG. 5 is an example interface that summarizes job configuration details in plain language in accordance with principles of inventive concepts; and

FIGS. 6A through 6D depict a process of entering job configuration details, summarizing the details and presenting them to a user in plain language through a graphical user interface.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

Various embodiments of systems and methods in accordance with the inventive concepts automatically translate technical and abstract robot configuration settings into sentences that can be intuitively understood by a user of a fleet management system, regardless of their level of technical expertise. A user can read these sentences as confirmation that the system has interpreted their configuration correctly and that they haven't made any mistakes. The automatically generated description is intended to act as a secondary safeguard that a user can read and confirm that their configuration will produce the desired robot behavior.

In some embodiments, aspects of inventive concepts are reliant on the existence of the jobs framework (as detailed in U.S. Provisional Appl. 63/430,174 filed on Dec. 5, 2022, entitled Process Centric User Configurable Step Framework for Composing Material Flow Automation, which is incorporated herein by reference. In some embodiments, the plain English description that is generated is based on the configuration set within the “Job Builder” feature in a fleet management system.

The installation of industrial automation systems is inherently complex and generally requires significant technical expertise to complete and maintain. Various embodiments of systems and methods in accordance with aspects of inventive concepts could be applied broadly within automation installation workflows where greater user comprehension of the system is desired. Various embodiments of systems and methods in accordance with the inventive concepts could be applied wherever automation logic exists and needs to be clarified.

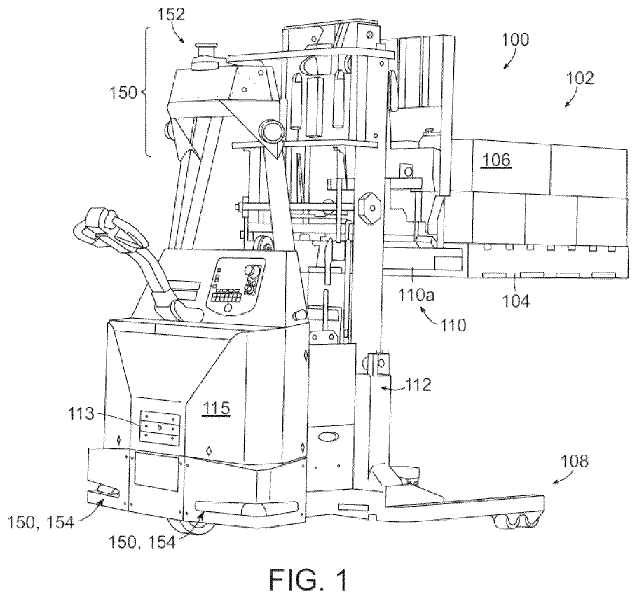

Although inventive concepts may be employed with any of a variety of autonomous mobile robots (AMRs) for brevity and clarity of description example embodiments will be primarily directed herein to AMR fork trucks, an example embodiment of which is illustrated in FIG. 1.

FIG. 1 is a perspective view of an embodiment of an AMR forklift 100 in accordance with aspects of the inventive concepts that includes features described herein. In some embodiments, such as the one shown in FIG. 1, the AMR includes a load engagement portion 110, such as a pair of forks 110a, 110b.

The forks 110 extend from the AMR in a first direction. The AMR may be configured to travel primarily in the first direction and, secondarily, in a second direction. The second direction can be considered opposite to the first direction, understanding that the AMRs have turning capability in both directions. When an AMR travels into an intersection in one direction, i.e., the first or second direction, changing the travel direction to the other of the first and second directions will be referred to as “reverse” motion herein. In some embodiments, a direction the AMR initially travels into the intersection with will be considered to be a forward direction and subsequently traveling within or through the same intersection in the opposite direction will be considered reversing direction or travelling in the reverse direction.

Aspects of inventive concepts disclosed herein relate to safely increasing the throughput of AMRs through areas of possible conflict. In various embodiments, a user interface can be provided to input intersection information, for example, during training of an AMR. The user interface (UI) can be provided on the AMR or on a computer that communicates with the AMR, such as a laptop, tablet, phablet, desktop, mobile phone, or other such computer device having a user interface. A “wizard” may be generated at or within the UI to assist a user in inputting information necessary for travel through one or more intersections, e.g., the wizard user interface can present computer displays that guide a user through entering intersection information.

In some embodiments, aspects of the inventive concepts are configured to work with Seegrid AMRs, such as Seegrid's Palion™ line of AMRs. In some embodiments, aspects of the inventive concepts disclosed herein are configured to work with a warehouse management system (WMS), such as Seegrid Supervisor™, as described in greater detail below. In other embodiments, systems and methods in accordance with the inventive concepts can be implemented with other forms of autonomously navigated vehicles and/or mobile robots and warehouse management systems.

In example embodiments a robotic vehicle may include a user interface, such as a graphical user interface, which may also include audio or haptic input/output capability, that may allow feedback to be given to a human-trainer while registering a piece of industrial infrastructure (such as a pallet) to a particular location in the facility using a Graphical Operator Interface integral to the AMR. The interface may include a visual representation and associated text. In alternative embodiments, the feedback device may include a visual representation without text.

In some embodiments, the systems and methods described herein rely on the Grid Engine for spatial registration of the descriptors to the facility map. Some embodiments of the system may exploit features of “A Hybrid, Context-Aware Localization System for Ground Vehicles” which builds on top of the Grid Engine, Application No. PCT/US2023/016556, which is hereby incorporated by reference in its entirety. Some embodiments may leverage a Grid Engine localization system, such as that provided by Seegrid Corporation of Pittsburgh, PA described in U.S. Pat. Nos. 7,446,766 and 8,427,472, which is incorporated by reference in its entirety.

In some embodiments, an AMR may interface with industrial infrastructure to pick and drop pallets, for example. In order for an AMR to accomplish this, its perception and manipulation systems in accordance with principles of inventive concepts may maintain a model for what a pallet is, as well as models for all the types of infrastructure for which it will place the pallet (e.g., tables, carts, racks, conveyors, etc.). These models are software components that are parameterized in a way to influence the algorithmic logic of the computation.

In example embodiments a route network may be constructed by an operator through training-by-demonstration, wherein an operator leads the AMR through a training route and inputs behaviors (for example, picks or places) along the route. A build procedure employs information gathered during training (for example, odometry, grid information including localization information, and operator input regarding behaviors) into a route network. The route network may then be employed by an AMR to autonomously follow during normal operation. The route network may be modeled, or viewed, as a graph of nodes and edges, with stations as nodes and trained segments as edges. Behaviors may be trained within segments. Behaviors may include “point behaviors” such as picks and drops or “zone behaviors” such as intersections. In example embodiments an AMR's repetition during normal operations of a trained route may be referred to as a “follow.” Anything, other than the follow itself, the AMR does during the follow may be viewed as a behavior. Zones such as intersections may include behaviors that are performed before, during, and/or after the zone. For intersections, the AMR requests access to the intersection from a supervisory system, also referred to herein as a supervisor or supervisory processor, (for example, Supervisor™ described elsewhere herein) prior to reaching the area covered by the intersection zone. When the AMR exits the zone, it releases that access to the supervisory system.

Referring to FIG. 1, shown is an example of a robotic vehicle 100 in the form of an AMR that can be configured with the sensing, processing, and memory devices and subsystems necessary and/or useful for lane building or depletion in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second fork 10a,b. Outriggers 108 extend from the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation. The sensors 150 can include one or more cameras, stereo cameras 152, radars, and/or laser imaging, detection, and ranging (LiDAR) scanners 154. One or more of the sensors 150 can form part of a 2D or 3D high-resolution imaging system.

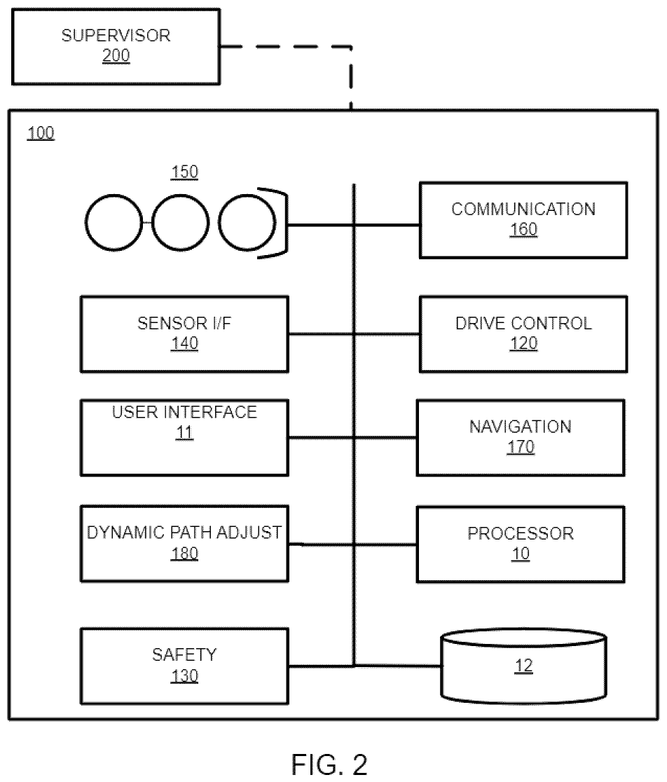

FIG. 2 is a block diagram of components of an embodiment of the robotic vehicle 100 of FIG. 1, incorporating intersection access technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, Wi-Fi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. Intersection behaviors, such as access requests or access release behaviors, may be input by a trainer when an AMR is being trained on a path. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (I/F) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In example embodiments a trainer may employ an AMR's user interface 11 to load behaviors as the trainer trains the AMR to execute a path. The behavior may be associated with entering an intersection when an intersection is encountered along the AMR's training path. Similarly, a trainer may employ the AMR's user interface 11 to load a behavior associated with exiting an intersection when the AMR encounters an exit along the AMR's training path. The locations of intersections may be known to the trainer before training the AMR, may be identified by the trainer as the trainer is training the AMR, or may be delivered to the trainer as the trainer executes the training process, from a processor, such as a supervisory processor, for example.

In example embodiments an entrance behavior may include the AMR's contacting of a processor, such as a supervisory processor, to request access to the intersection in question. That is, during training, the AMR may be trained to execute an intersection entrance behavior that includes requesting access to the intersection from a supervisory processor. In its request the AMR may include information that enables the supervisory processor to determine whether the requesting AMR may have access to the intersection or what type or access the AMR may have to the intersection. Such information may include an AMR identifier, the AMR's path, and the type of travel the AMR is to make through the intersection, for example. The type of travel may include whether the AMR is traveling through the intersection in a straight line or it is altering its travel direction within the intersection. If, for example, the AMR is to turn within the intersection, it may reverse course to make the turn and this reversal may impact the type of access granted to the AMR by the supervisory processor. In some embodiments the behavior may include a fault activity, should the access not be granted for an extended period of time. The fault activity may include contacting the supervisory processor, setting an alarm, providing visual, or other indicia of access failure, for example.

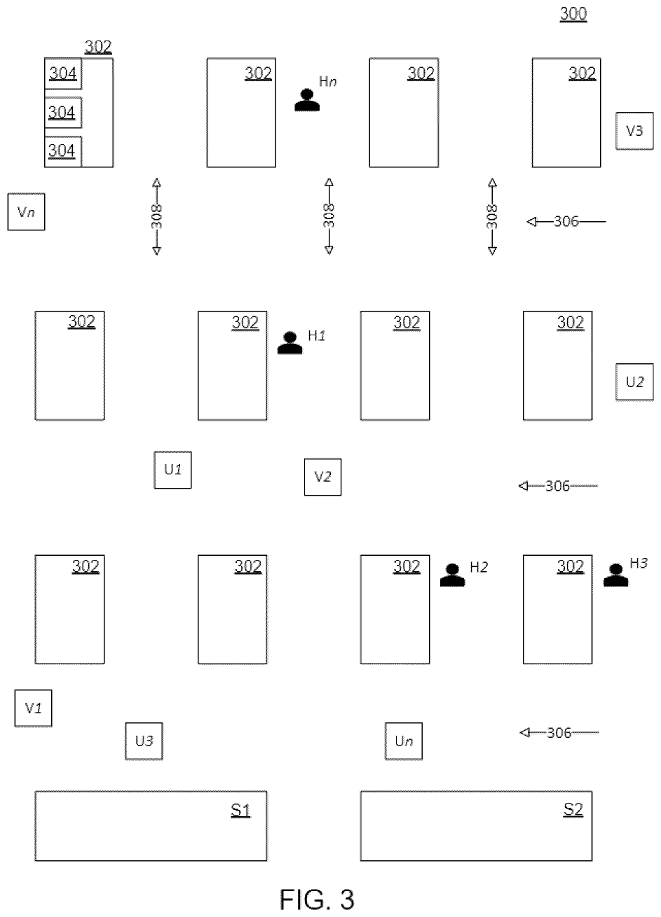

FIG. 3 depicts a warehouse in which an example embodiment of a system and method in accordance with principles of inventive concepts may be employed. In example embodiments a material flow system in accordance with principles of inventive concepts may be implemented in a facility such as a manufacturing, processing, or warehouse facility, for example. For brevity and clarity of description the example embodiments described herein will generally be in reference to warehouse implementations, but inventive concepts are not limited thereto.

In the example embodiment of FIG. 3 items are stored in storage racks 302 distributed throughout a warehouse 300. Storage racks 302 may be divided into bays 304 and bays 304 may be further divided into shelves, for example. Racks 302 may be configured to store items within bins, on any of a variety of pallets, or other materials handling storage units. Racks 302 may be single- or multi-level, for example, and may vary in width, length, and height. Staging areas S1 and S2 may be used to temporarily store items for shipping or receiving, respectively, to/from transportation means, such as truck or train for example, to external facilities. Rows 306 and aisles 308 provide access to storage racks 302. Vehicles V1, V2, V3 . . . Vn, may be of any of a variety of types, described for example, in the discussion related to FIG. 1 and may be operated to move items among racks 302 and staging areas S1, S2. Although, in practice, vehicles V1, V2, V3 . . . , Vn may be any type of vehicle, for this example embodiment we will assume that they are AMRs. One or more user interfaces UI1, UI2, UI3 . . . , Un may be distributed throughout the warehouse 300. The user interfaces UI1, UI2, UI3 . . . , Un may be employed by an operator to interact with a system such as one described in the discussion related to FIG. 2 to direct a vehicle to pick an item from one location (a specific storage rack, for example) and to place it in another location (staging area S1, for example). The user interfaces, UI1, UI2, UI3 . . . , Un, may be included within AMRs, may be in standalone screens or kiosks positioned throughout the warehouse, may be handheld electronic devices, or may be implemented as applications on smartphones or tablets, for example.

In contrast with a conventional approach that requires an operator to lay out every move with precision, covering all the alternative possibilities, a system and method in accordance with principles of inventive concepts allows an operator to initiate the movement of items within a facility such as a warehouse with a high degree of flexibility and ease. In example embodiments a system and method in accordance with principles of inventive concepts may allow an operator (also referred to herein as a user) to configure the movement of materials from one location to another within a facility such as a warehouse. Such movement may be, for example, the movement of one or more items from a storage area to a staging area, or vice versa, the movement of one or more items from a staging area to a storage area. Such movement may be referred to herein as a “job.” A job may be created to fill an order for example, and may entail the movement of one or more items from one or more storage areas by one or more vehicles to a staging area. At the staging area the items are assembled for loading and shipping. On the other hand a job may entail one or more vehicles moving items from a receiving area to one or more locations within the facility. Humans H1, H2, H3 . . . Hn may work in the warehouse alongside vehicles V1-Vn, some or all of which may be AMRs.

In an example embodiment a plurality of AMRs (e.g., vehicles V1-Vn) are in communication with a warehouse management system (WMS), in accordance with aspects of inventive concepts, which may be implemented on the supervisory processor 200, for example. One or more humans (H1-Hn) are also working within the environment and communicated with the WMS. The humans and the AMRs can also communicate directly, in some embodiments. In some embodiments, the humans can order pickers that load goods on AMRs at pick locations within the warehouse environment. The humans may employ handheld electronic devices through which they can communicate with the WMS and/or the AMRs.

In some embodiments, the humans can be stationed, at least for a duration of time, in a pick zone and/or at a pick location (at a bay 304 within the upper leftmost rack 302) and load goods onto different AMRs as they navigate through the pick zone and/or to the pick location. In some embodiments, a pick zone can have multiple pick locations.

In some embodiments, a fleet management system (FMS) and/or warehouse management system (WMS), either one or both of which may be implemented on supervisory processor 200, can wirelessly communicate with all of the AMRs and monitor their status, assign a next task, and/or instruct navigation or a non-work location.

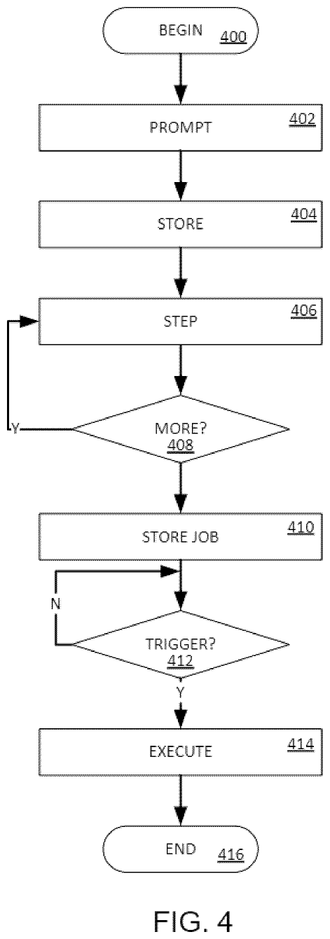

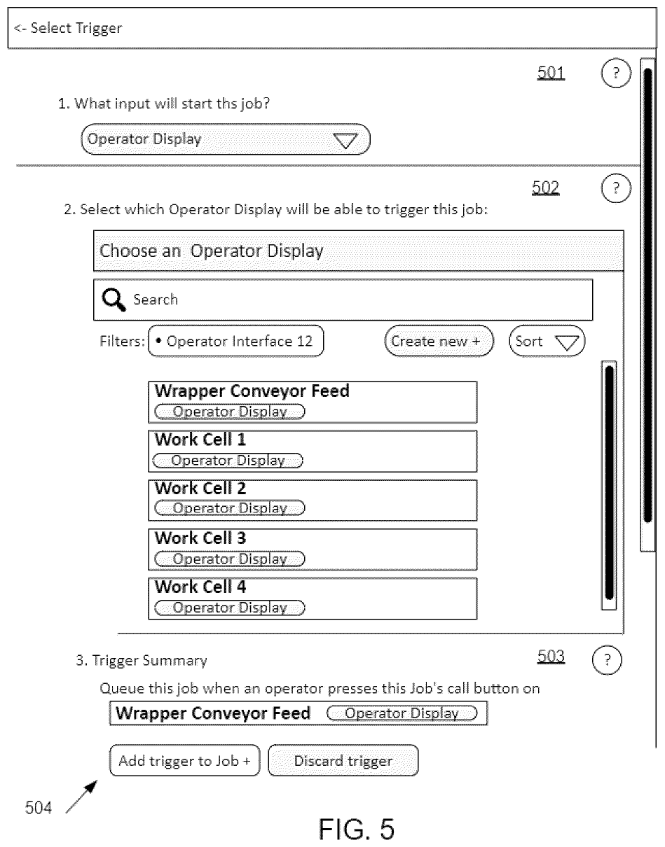

The flowchart of FIG. 4 depicts an example embodiment of a process for job creation, that is a material flow process creation, in accordance principles of inventive concepts. The process begins in step 400 where the system, through a processor such as supervisory processor 200 as previously described, responds to input from an operator, which may have been input through a user interface such as a user interface UI1, UI2, UI3 . . . , Un. The process proceeds from step 400 to step 402 where a processor, such as supervisory processor 200 or a processor implemented within the user interface device, provides an input screen and prompts the operator to enter the requisite input for the formation of a material flow process, or job. In step 404 the system stores a trigger that has been entered by the operator and prompts the operator to begin entering step information (e.g., “go here and do this”) as previously described. One of the great advantages of a system and method in accordance with principles of inventive concepts is that the system, through a fleet management function, keeps tabs on what type of vehicles may be in the warehouse, what type of storage (e.g., pallet or bin) the vehicles can handle, and what type of storage is used for every item in the warehouse. An operator only needs to indicate where a vehicle is to proceed and what it is to do when it gets there; the system determines which vehicle of which type will be dispatched to execute the operation. When the step information is entered, which may include “group location information,” as described in greater detail in the discussion related to FIG. 5, the process proceeds to step 408 where the system determines whether there are more steps to the job being entered. This determination may be made through an operator input, through a separate command or through an entry within a step screen. If there are more steps for the job, the process returns to step 406 and on from there as described. If there are no more steps, the process proceeds to step 410 where the system stores the job. In step 412 the process monitors the appropriate inputs to determine when a trigger conditions has been met. If the trigger condition has been met the process proceeds to step 414 where the system executes the job. As previously noted, during execution of the job the system may select one or more appropriate AMRs to execute the job, according to their load handling capabilities and the type of load involved. When the job is completed the process proceeds to end in step 416.

In example embodiments jobs, or material flow processes, may be configured locally with a processor and application included in a user interface devices, such as a smartphone, tablet, or dedicated user interface device; through a facility-wide device such as a supervisory processor that includes a fleet management system; or through a web application, for example. In example embodiments the process entails: giving the job a case-insensitive unique name that is used in a user interface including an operator display to identify the job. The job is given a trigger event and the trigger. In example embodiments the trigger event can be input from an operator display, from a PLC, from fleet management processor, for example. In example embodiments, an operator may specify a robot group, which allows the operator to select a group of robots within the facility from which an AMR is to be selected to execute the job when it is triggered. Robot groups may be organized according to the type of robot (e.g., tugger or forklift), according to the type of material they are designed to move, or according to other criteria.

Once a job, created by an operator, has been saved by a system in accordance with principles of inventive concepts, it may be requested, or initiated, by the specified trigger. A jobs framework in accordance with principles of inventive concepts is not AMR dependent and may be applied to any of a variety of AMR chassis, regardless of manufacturer of type (e.g., taxi, trucking, etc.).

In example embodiments a system and method in accordance with principles of inventive concepts may provide an operator with information in a form that ensures that the operator's entries into the system are not misunderstood. To accomplish this, the system and method may present messages to the operator during the course of command entry that reflects the commands the operator has input in ‘plain language.” By “plain language” we mean language that approximates natural language, that employs syntax and is in sentence form. By employing plain language in this manner an operator may ensure that his entries have been properly recorded by the system and that, as a result, his material flow jobs will be carried out as he envisions. Plain language responses may be output to the operator at various intervals, whether at the step level or sub-step level to ensure that the operator has an opportunity to correct any entries that may have been misinterpreted as the job entry proceeds.

When a trigger entry entered (see step 402, for example) the system may provide a plain language description of the selected trigger criteria to the operator before storing the trigger information in step 404. Similarly, the system may provide a plain language description of the various selections made during the configuration of a step, such as in step 406, at the end of the step configuration or at a plurality of points during the configuration of the step. Providing additional feedback, employing greater granularity, allows an operator to “check his work” as he goes, thereby allowing for more accurate input an reducing any frustration that may occur were an error be detected after a lengthy series of inputs. In example embodiments a system and method in accordance with principles of inventive concepts may accept a series of configuration settings (e.g., trigger selection, step information with location-specific and behavior-specific information, location group information, robot group information, etc.) and at one or more steps during a process such as a configuration process whereby a job template is presented to a user and accepts user input, the system echoes user input in plain language that a user may more readily understand than simple the simple disjointed phrases of robot commands. When we say that user input is echoed in plain language, we mean that the input is presented to a user in one or more complete sentences. By such presentation a system and method in accordance with principles of inventive concepts converts a series of configuration settings that are conceptually abstract and echoes them back to the user in the form of sentences to improve comprehension. This improves productivity and accuracy or all users and is of particular benefit to a neophyte in the realm of autonomous robotics, as it helps them better navigate the process and allows them to check that their configuration is producing the desired effect.

FIG. 5 illustrates an example embodiment of a graphical user interface (GUI), in accordance with aspects of inventive concepts. In some embodiments, an operator, e.g., a human user, can operate a handheld device that presents the GUI. Alternatively, or additionally, in some embodiments, the GUI displays on a screen not associated with a handheld device.

In some embodiments, the user interface may be employed in a job configuration process as previously described and in such embodiments the user interface may present elements such as illustrated in FIG. 5. In example embodiments an operator may create a new job by first naming the job. Then the operator configures a “trigger” section of the job, as previously described. The trigger section defines how and when the job will start. As illustrated in segment 501 of the user interface, in an example embodiment the system queries the operator with the statement “what input will start this job?,” and provides a pulldown menu that lists options for starting the job: that is, lists optional triggers. Trigger options include “operator display” (meaning that the trigger will be input through an operator display by an operator). Triggers may include: Operator Display, PLC, WMS, Arrival at station, Schedule-Based, Periodic (every t seconds), Integration (could point to a custom adapter that integrates with some external system not generally supported), or Need-based (some state indicates a location needs replenishment), for example. In the example of FIG. 5, an operator display is the trigger selected by an operator. The system then prompts the operator to select a specific instance of the trigger (e.g., operator display, PLC, or other) that will drive the trigger action, as illustrated in screen segment 502. The instances provided in this example embodiment include “wrapper conveyor feed,” “work cell 1,” “work cell 2,” etc. and in this example an operator has selected “wrapper conveyor feed” as the trigger. In accordance with principles of inventive concepts a system and method may generate and present to an operator a plain language description of the tentative choice the operator has made. The plain language description may be generated by the system, for example, using a processor such as that of supervisory processor 200 to execute a variable lookup process, for example. In a job configuration process variables are generated in, for example, configuring a trigger or step and a system and method in accordance with principles of inventive concepts employs the variable selections by storing and linking the selections together to form a sentence when the configuration process or a portion thereof is completed. Other methods of generating plain language text for presentation to an operator are contemplated within the scope of inventive concepts. In the example embodiment of FIG. 5 a plain language message, “Queue this job when an operator presses this job's call button on . . . wrapper conveyor feed operator display” is displayed as a “Trigger Summary” (GUI element 503) to echo back to the operator the configuration they have just (tentatively) set. The system provides, in GUI element 504, an operator the opportunity to the trigger to the job or to discard the trigger from the job, the decision for which will be aided by the system's plain language echo of the operator's selections.

As with the creation of triggers, the system provides plain language echoes of selections made during the configuration of job steps. As previously described, each step may include two elements that can be described as “Go Here” and “Do This.” Once the operator has created and configured their desired steps the operator may request a review of their tentative selections by requesting a summary. In example embodiments, a system and method in accordance with inventive concepts may provide a “Job Summary” tab on the GUI supported, for example, by supervisory processor 200 in a job builder tool within a fleet management system for such a purpose. With the job summary provided by the system the operator can read through their job steps in paragraph form to confirm the accuracy of the job configuration (e.g., “Step 1, the robot will travel to location 13 to pick a pallet, Step 2, etc.) In example embodiments systems and methods in accordance with inventive concepts may be applied to various aspects including, but not limited to: Job descriptions, Trigger descriptions, Integration descriptions (that is, how an external system such as a PLC engages with AMRs), configuring data reporting on system performance, configuring power management logic and scheduling, and error reporting (where errors are stated in plain language, rather than as a cryptic message such as “error code BC0022,” for example.

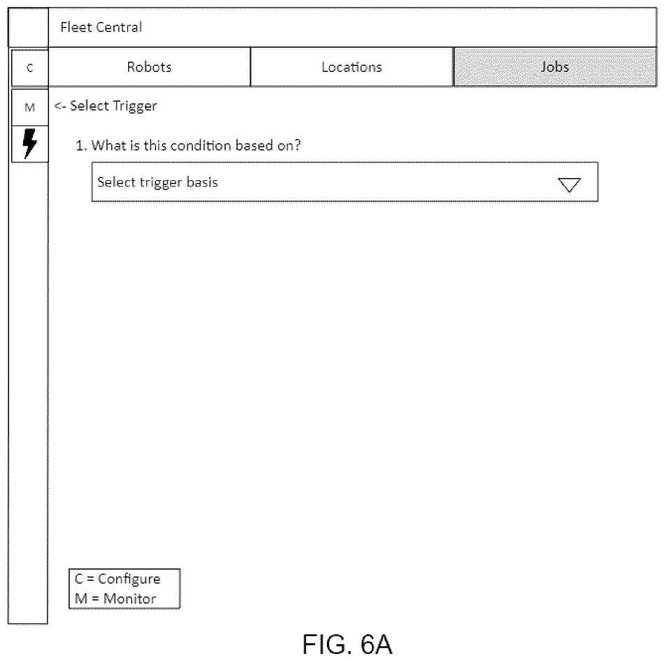

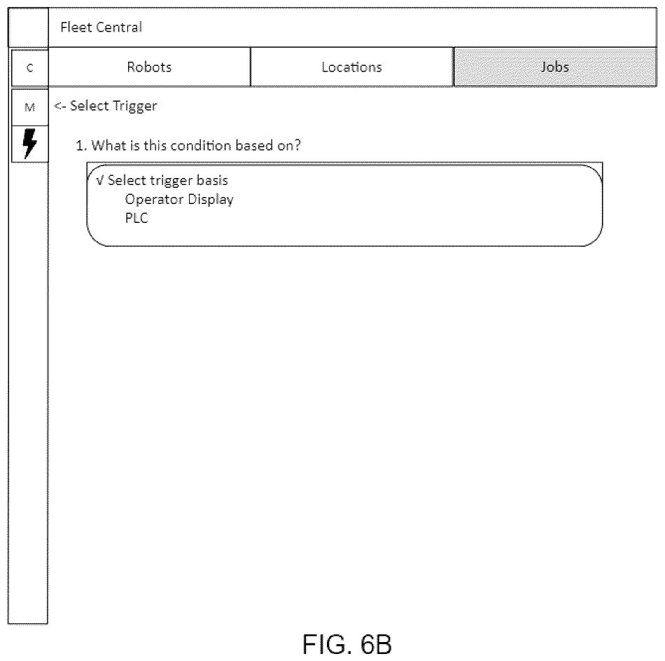

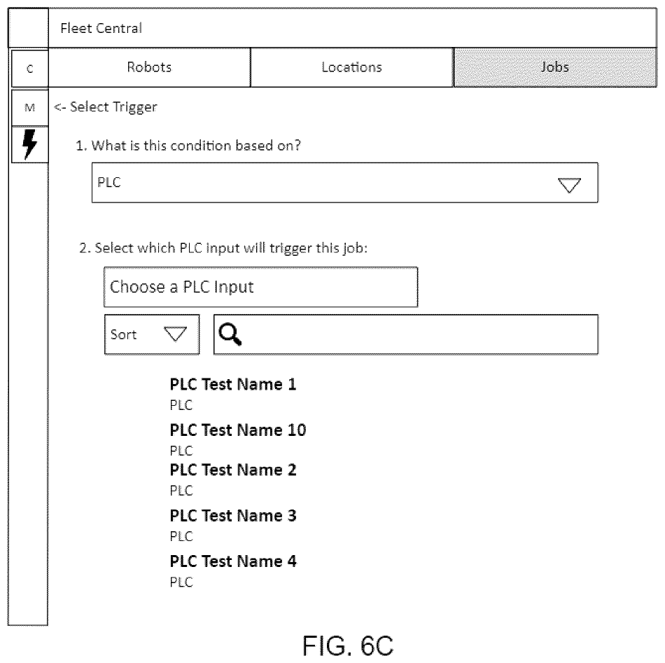

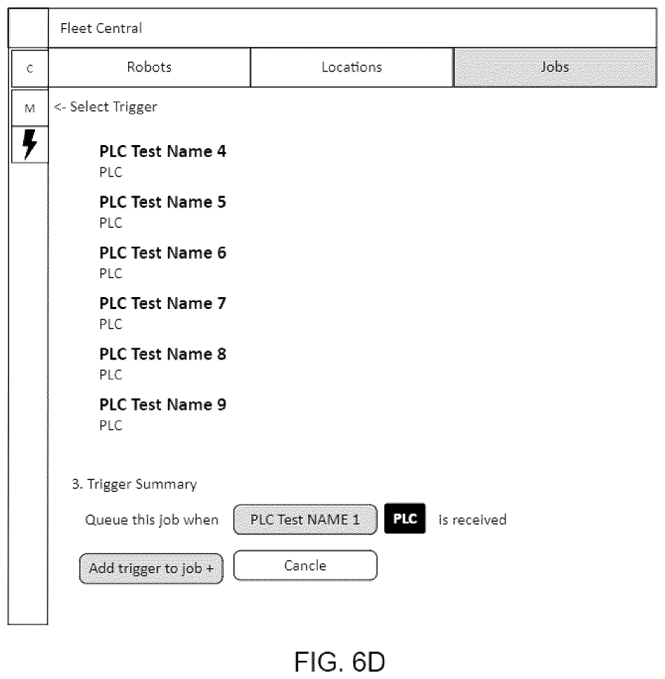

FIGS. 6A through 6D illustrate a similar series of interactions between a system in accordance with principles of inventive concepts and an operator configuring a trigger, where a trigger selection prompt is provided through a GUI (FIG. 6A), the option of an operator display or PLC is provided (FIG. 6B), a PLC is tentatively selected and choice of PLCs is prompted by the system (FIG. 6C), and the trigger selection is summarized by the system in plain language, “Queue this job when PLC Test Name 1 is received” (FIG. 6D).

In accordance with aspects of inventive concepts. In some embodiments, an operator, e.g., a human user, can operate a handheld device that presents the GUI. Alternatively, or additionally, in some embodiments, the GUI displays on a screen are not associated with a handheld device.

The inventive concepts can be implemented as part of a total automated mobile robot (AMR), fleet management system (FMS), warehouse management system (WMS), or other system which can take the form of a total package of hardware, software and integrations that allows a customer to establish material flow automation in their facility. In various embodiments described herein there are multiple variations of how selections for the system are made. These selections could be via a human operator and/or another automation system.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provide in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

Below follows an itemized list of statements describing embodiments in accordance with the inventive concepts:

1. A system, comprising:
a material flow management system comprising a processor configured to:
accept from a user one or more robotic material flow job configuration details;
translate the one or more configuration details into one or more plain language summaries of the job configuration details; and
provide the one or more plain language summaries of job configuration details to a user via a display.

2. The system of statement of 1, or any other statement or combinations of statements, wherein the system is configured to provide the one or more plain language summaries to a user through a graphical user interface.

3. The system of statement of 2, or any other statement or combinations of statements, wherein the system is configured to prompt a user to accept or reject job configuration details in response to the presentation of a plain language summary of the configuration details.

4. The system of statement of 3, or any other statement or combinations of statements, wherein the system is configured to respond to the acceptance of configuration details by storing the configuration details as a template for a robotic material flow job.

5. The system of statement of 4, or any other statement or combinations of statements, wherein the system is configured to prompt the input of configuration details, including a trigger and a step, for the robotic material flow job configuration.

6. The system of statement of 5, or any other statement or combinations of statements, wherein the system is configured to present the stored template to a user when the job is called and is responsive to user input regarding job configuration specifications to provide an instance of the job.

7. The system of statement of 6, or any other statement or combinations of statements, wherein the system is configured to accept location-specific input in the form of a direct location within a facility managed by the system in the context of the stored template.

8. The system of statement of 6, or any other statement or combinations of statements, wherein the system is configured to accept location-specific input in the form of a group of locations within a facility managed by the system in the context of the stored template.

9. The system of statement of 6, or any other statement or combinations of statements, wherein the system is configured to accept input in the form of a group of robots within a facility managed by the system in the context of the stored template.

10. A method, comprising:
a material flow management system comprising a processor:
accepting from a user one or more robotic material flow job configuration details;
translating the one or more configuration details into one or more plain language summaries of the job configuration details; and
providing the one or more plain language summaries of job configuration details to a user via a display.

11. The method of statement of 10, or any other statement or combinations of statements, wherein system provides the one or more plain language summaries to a user through a graphical user interface.

12. The method of statement of 11, or any other statement or combinations of statements, wherein the system prompts a user to accept or reject job configuration details in response to the presentation of a plain language summary of the configuration details.

13. The method of statement of 12, or any other statement or combinations of statements, wherein the system responds to the acceptance of configuration details by storing the configuration details as a template for a robotic material flow job.

14. The method of statement of 13, or any other statement or combinations of statements, wherein the system prompts the input of configuration details, including a trigger and a step, for the robotic material flow job configuration.

15. The method of statement of 14, or any other statement or combinations of statements, wherein the system presents the stored template to a user when the job is called and is responsive to user input regarding job configuration specifications to provide an instance of the job.

16. The method of statement of 15, or any other statement or combinations of statements, wherein the system accepts location-specific input in the form of a direct location within a facility managed by the system in the context of the stored template.

17. The method of statement of 15, or any other statement or combinations of statements, wherein the system accepts location-specific input in the form of a group of locations within a facility managed by the system in the context of the stored template.

18. The method of statement of 15, or any other statement or combinations of statements, wherein the system accepts input in the form of a group of robots within a facility managed by the system in the context of the stored template.

19. A robotic materials flow system, comprising:
an AMR;
a processor configured to:
accept from a user one or more robotic material flow job configuration details;
translate the one or more configuration details into one or more plain language summaries of the job configuration details; and
provide the one or more plain language summaries of job configuration details to a user via a display.

20. The system of statement of 19, or any other statement or combinations of statements, wherein the processor is configured to prompt the user to accept or reject the configuration details based on the plain language summaries and to store the job configuration details as a template in response to user acceptance of the details.

What is claimed is:

1. A system, comprising:
a material flow management system comprising a processor configured to:
accept from a user one or more robotic material flow job configuration details;
translate the one or more configuration details into one or more plain language summaries of the job configuration details; and
provide the one or more plain language summaries of job configuration details to a user via a display.

2. The system of claim 1, wherein the system is configured to provide the one or more plain language summaries to a user through a graphical user interface.

3. The system of claim 2, wherein the system is configured to prompt a user to accept or reject job configuration details in response to the presentation of a plain language summary of the configuration details.

4. The system of claim 3, wherein the system is configured to respond to the acceptance of configuration details by storing the configuration details as a template for a robotic material flow job.

5. The system of claim 4, wherein the system is configured to prompt the input of configuration details, including a trigger and a step, for the robotic material flow job configuration.

6. The system of claim 5, wherein the system is configured to present the stored template to a user when the job is called and is responsive to user input regarding job configuration specifications to provide an instance of the job.

7. The system of claim 6, wherein the system is configured to accept location-specific input in the form of a direct location within a facility managed by the system in the context of the stored template.

8. The system of claim 6, wherein the system is configured to accept location-specific input in the form of a group of locations within a facility managed by the system in the context of the stored template.

9. The system of claim 6, wherein the system is configured to accept input in the form of a group of robots within a facility managed by the system in the context of the stored template.

10. A method, comprising:
a material flow management system comprising a processor:
accepting from a user one or more robotic material flow job configuration details;
translating the one or more configuration details into one or more plain language summaries of the job configuration details; and
providing the one or more plain language summaries of job configuration details to a user via a display.

11. The method of claim 10, wherein system provides the one or more plain language summaries to a user through a graphical user interface.

12. The method of claim 11, wherein the system prompts a user to accept or reject job configuration details in response to the presentation of a plain language summary of the configuration details.

13. The method of claim 12, wherein the system responds to the acceptance of configuration details by storing the configuration details as a template for a robotic material flow job.

14. The method of claim 13, wherein the system prompts the input of configuration details, including a trigger and a step, for the robotic material flow job configuration.

15. The method of claim 14, wherein the system presents the stored template to a user when the job is called and is responsive to user input regarding job configuration specifications to provide an instance of the job.

16. The method of claim 15, wherein the system accepts location-specific input in the form of a direct location within a facility managed by the system in the context of the stored template.

17. The method of claim 15, wherein the system accepts location-specific input in the form of a group of locations within a facility managed by the system in the context of the stored template.

18. The method of claim 15, wherein the system accepts input in the form of a group of robots within a facility managed by the system in the context of the stored template.

19. A robotic materials flow system, comprising:
an AMR;
a processor configured to:
accept from a user one or more robotic material flow job configuration details;
translate the one or more configuration details into one or more plain language summaries of the job configuration details; and
provide the one or more plain language summaries of job configuration details to a user via a display.

20. The system of claim 19, wherein the processor is configured to prompt the user to accept or reject the configuration details based on the plain language summaries and to store the job configuration details as a template in response to user acceptance of the details.
